(19) United States
(12) Patent Application Publication
(10) Pub. No.: US 2003/0215208 A1
(43) Pub. Date: Nov. 20, 2003

(54) Variable optical attenuator

(76) Inventors: Yen-Zen Lee, Hsinchu (TW); Ren-Hong Cheng, Hsinchu (TW); Tar-Li Hsieh, Kaohsiung (TW)

Correspondence Address: BIRCH STEWART KOLASCH & BIRCH, PO BOX 747, FALLS CHURCH, VA, 22040-0747, US

(21) Appl. No.: 10/247,537

(22) Filed: Sep. 20, 2002

(30) Foreign Application Priority Data
May 14, 2002 (TW) 91110045

(51) Int. Cl. G02B 6/00

(52) U.S. Cl. 385/140

(57) ABSTRACT

A variable optical attenuator. The variable optical attenuator has a ferrule with a hole, an optical fiber disposed in the hole of the ferrule, a lens module having a highly reflective mirror and a GRIN lens with two surfaces, and a driving device connected to the lens module for moving the lens module relative to the ferrule. In the lens module, one of the two surfaces of the GRIN lens is fixed to the highly reflective mirror, and a clearance is formed between the other surface of the GRIN lens and the ferrule. The driving device may be a piezoelectric actuator or a microactuator, and the fiber may include an input fiber and an output fiber.

### BACKGROUND OF THE INVENTION

1. Field of the Invention

The present invention relates to a variable optical attenuator.

2. Description of the Related Art

In a fiber optic network, light is applied as an optical signal to transfer information from one location to another along optical fibers. Since the optical signal strength may exceed a detectable range at the receiving end, it is desirable to tailor or attenuate the power of the optical signal within the optical fiber network. Generally, an optical attenuator is applied to tailor the power of the optical signal to a desired value of the optical fiber network. If the attenuating process of the power of the optical signal is adjustable, the optical signal strength can be precisely tailored. In this case, accordingly, a variable optical attenuator (VOA) is applied to attenuate the power of the optical signal.

Various types of conventional variable optical attenuators have been proposed for application. Generally, a conventional variable optical attenuator is constituted so that position of each element of the variable optical attenuator can be adjusted relatively. Thus, the adjustment changes the optical path of the variable optical attenuator, and the optical signal is adjustably attenuated.

For example, U.S. Pat. No. 6,130,984 discloses a conventional variable optical attenuator, in which a variable filter is disposed between the GRIN lens and a reflector. When an optical signal is input to an input fiber, the signal is transmitted from the GRIN lens to the reflector through the variable filter. In this case, the variable filter is moved to adjustably attenuate the optical signal. Then, the optical signal travels back toward the GRIN lens from the reflector through the variable filter via the same optical path, and is outputted to an output fiber.

U.S. Pat. No. 6,285,504 discloses another conventional variable optical attenuator. In the conventional variable optical attenuator, the reflector is attached to an elastic member with a high coefficient of heat expansion. When the surrounding temperature changes, the elastic member deforms to move the reflector, so that the optical path is changed to the attenuate the optical signal.

However, additional elements, such as the variable filter or the elastic member, are required in the above-mentioned conventional variable optical attenuators, which increase the manufacturing time and cost.

Further, in the conventional variable optical attenuator disclosed in U.S. Pat. No. 6,130,984, the variable filter is a high-cost device with a relatively large volume to the variable optical attenuator, so that the variable optical attenuator is not preferable in application to the field of MEMS.

Further, in the conventional variable optical attenuator disclosed in U.S. Pat. No. 6,285,504, the elastic member deforms due to the temperature change. Accordingly, a precise temperature control device is required, which further increases manufacturing time and cost of the variable optical attenuator.

### SUMMARY OF THE INVENTION

In view of this, the present invention relates to a variable optical attenuator. In the variable optical attenuator of the present invention, the reflective mirror and the GRIN lens are coupled as a lens module, and a low-cost driving device, such as an actuator of piezoelectric material, with a relatively smaller size is applied to change the position of the lens module relative to other elements of the variable optical attenuator. The driving device is smaller and less expensive than the variable filter applied in the conventional variable optical attenuator and can be controlled regardless of temperature change. As a result, the variable optical attenuator of the present invention performs stably with reduced size and cost.

The present invention discloses a variable optical attenuator, which has a ferrule with a hole, an optical fiber disposed in the hole of the ferrule, a lens module having a highly reflective mirror and a GRIN lens with two surfaces, and a driving device connected to the lens module for moving the lens module relative to the ferrule. In the lens module, one of the two surfaces of the GRIN lens is fixed to the highly reflective mirror, and a clearance is formed between the other surface of the GRIN lens and the ferrule.

In the variable optical attenuator of the present invention, the driving device may be a piezoelectric actuator or a microactuator, such as a micro-motor, and the fiber may include an input fiber and an output fiber. Further, since one of the two surfaces of the GRIN lens is fixed to a highly reflective mirror, the highly reflective mirror can be simplified as a highly reflective film coated on one of the surfaces of the GRIN lens, so that the film performs reflection at a relatively low cost.

Further, the lens module can be moved three-dimensionally. For example, the driving device may move the lens module relative to the ferrule in a direction substantially perpendicular to the optical fiber or in a direction substantially parallel to the optical fiber for changing the clearance between the GRIN lens of the lens module and the ferrule. As well, the driving device may control the lens module to rotate relative to the ferrule for changing the clearance and an angle between the GRIN lens of the lens module and the ferrule.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic view showing the variable optical attenuator of the present invention;

FIG. 2 is a schematic view showing an embodiment of the variable optical attenuator of the present invention;

FIG. 3 is a schematic view showing another embodiment of the variable optical attenuator of the present invention;

FIG. 4 is a schematic view showing another embodiment of the variable optical attenuator of the present invention;

FIG. 5 is a diagram showing an embodiment of the insertion loss of the variable optical attenuator of the present invention; and

FIG. 6 is a diagram showing another embodiment of the insertion loss of the variable optical attenuator of the present invention.

### DETAILED DESCRIPTION OF THE INVENTION

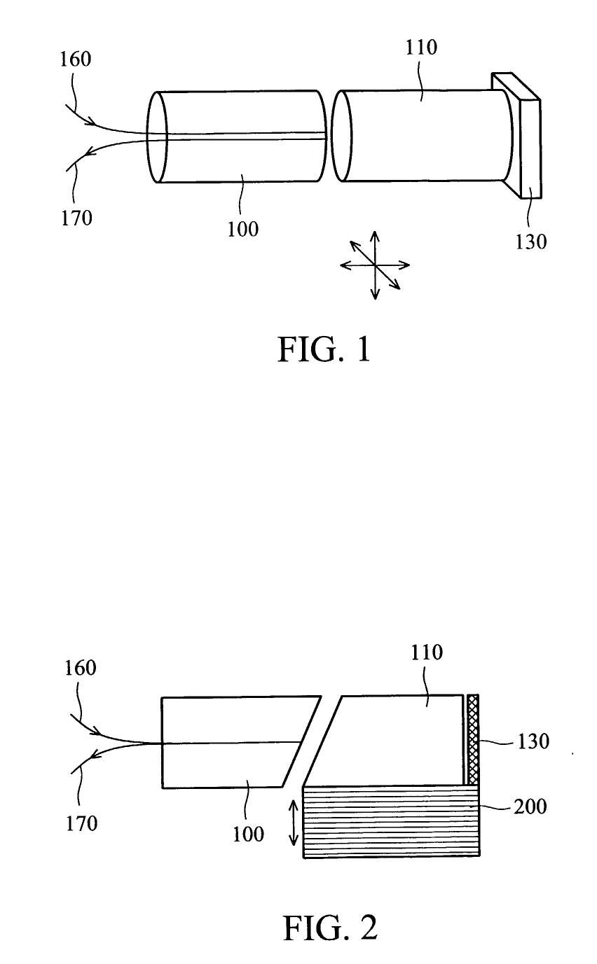

A schematic structure of the variable optical attenuator of the present invention can be described in detail with reference to FIG. 1.

The variable optical attenuator as shown in FIG. 1 has a ferrule 100, optical fibers including an input fiber 160 and an output fiber 170, a GRIN lens 110 with two surfaces, and a highly reflective mirror (HR mirror) 130. Further, the variable optical attenuator of the present invention has a driving device, not shown in FIG. 1.

The ferrule 100 has a hole, and the input fiber 160 and the output fiber 170 are disposed in the hole of the ferrule 100 to form a dual fiber pigtail. The HR mirror 130 and the GRIN lens 110 are coupled and fixed to each other to form a lens module. That is, in the lens module, one of the two surfaces of the GRIN lens 110 is fixed to the HR mirror 130. Further, the other surface of the GRIN lens 130 corresponds to the ferrule 100, and a clearance is formed between the GRIN lens 130 and the ferrule 100, so that the lens module can be moved relative to the ferrule 100. In this case, the lens module can be three-dimensionally moved or rotated under control of the driving device.

It should be noted that, since one of the two surfaces of the GRIN lens 110 is fixed to the HR mirror 130, the GRIN lens 110 can be constructed with a highly reflective film coated on one of the surfaces of the GRIN lens 110. Thus, the highly reflective film can be stably coated on the GRIN lens 110 to function as the HR mirror 130 in a simple coating process and at reduced cost.

The driving device of the variable optical attenuator of the present invention is connected to the lens module (that is, the GRIN lens 110 and the HR mirror 130) for moving the lens module relative to the ferrule 100. It is preferable to apply a piezoelectric actuator with any applicable structure as the driving device in order to obtain a variable optical attenuator of the present invention with reduced size and cost. Embodiments of the variable optical attenuator of the present invention with different forms of driving device can be described hereinafter with reference to FIGS. 2 to 4.

In an embodiment as shown in FIG. 2, the driving device is a stack-piezo actuator 200. The stack-piezo actuator 200 is connected to one side of the lens module (the GRIN lens 110 and the HR mirror 130). By controlling driving voltage of the stack-piezo actuator 200, the stack-piezo actuator 200 moves the lens module transversely to the ferrule 100. That is, the GRIN lens 110 and the HR mirror 130 are moved relative to the ferrule 100 in a direction substantially perpendicular to the optical fibers 160 and 170. Thus, the optical signal is attenuated by the variable optical attenuator.

It should be noted that the stack-piezo actuator 200 in FIG. 2 performs a displacement in the direction substantially perpendicular to the optical fibers 160 and 170, so that the lens module is moved transversely to the ferrule 100. However, the stack-piezo actuator 200 can be disposed differently to perform a displacement in a different direction, so that the lens module may be moved in a direction substantially parallel to the optical fibers 160 and 170, or in a direction with a specific angle to the optical fibers 160 and 170. In any case, the optical signal can be attenuated by the variable optical attenuator.

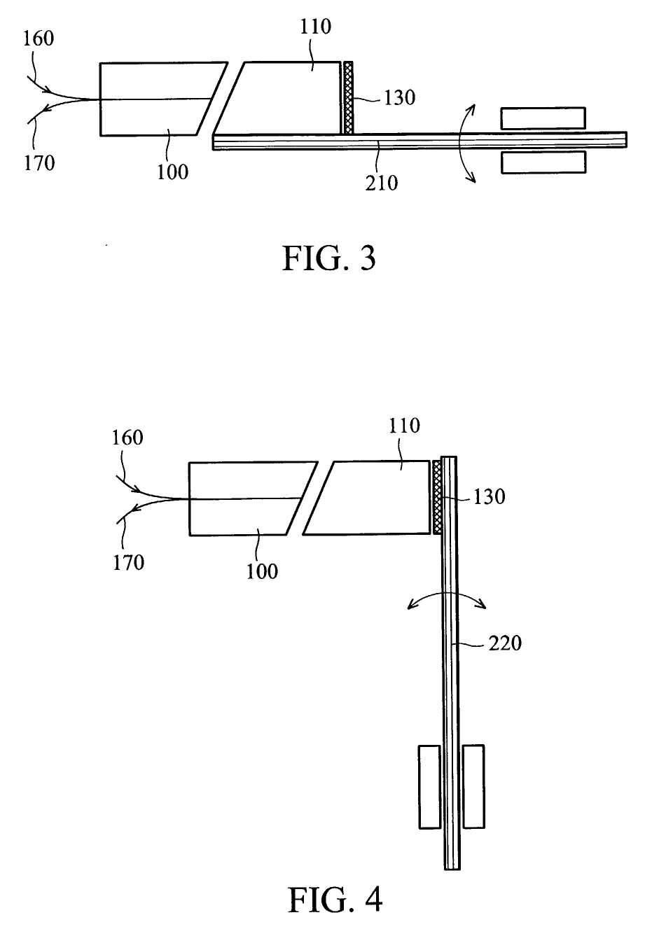

In a further embodiment as shown in FIG. 3, the driving device is a piezoelectric bimorph cantilever 210. The piezoelectric bimorph cantilever 210 is connected to one side of the lens module (the GRIN lens 110 and the HR mirror 130). By controlling driving voltage of the piezoelectric bimorph cantilever 210, the piezoelectric bimorph cantilever 210 performs upward or downward oscillation relative to the ferrule 100. That is, the GRIN lens 110 and the HR mirror 130 are moved and rotated relative to the ferrule 100 according to the oscillation of the piezoelectric bimorph cantilever 210. Thus, the clearance and the angle between the GRIN lens 110 of the lens module and the ferrule 100 are changed, and the optical signal is attenuated by the variable optical attenuator.

In a further embodiment as shown in FIG. 4, the driving device is a piezoelectric bimorph cantilever 220. The piezoelectric bimorph cantilever 220 is connected to the back surface of the HR mirror 130, different from the piezoelectric bimorph cantilever 210 in FIG. 3. Since the HR mirror 130 and the GRIN lens 110 are coupled and fixed to each other, by controlling driving voltage of the piezoelectric bimorph cantilever 220, the piezoelectric bimorph cantilever 210 performs inward or outward oscillation relative to the ferrule 100. That is, the HR mirror 130 and the GRIN lens 110 (fixed to the HR mirror 130) are moved and rotated relative to the ferrule 100 according to the oscillation of the piezoelectric bimorph cantilever 220. Thus, the clearance and the angle between the GRIN lens 110 of the lens module and the ferrule 100 are changed, and the optical signal is attenuated by the variable optical attenuator.

The variable optical attenuator of the present invention applies a low-cost driving device, such as the piezoelectric actuator with a relatively smaller size to control the position of the lens module relative to the ferrule 100, so that the variable optical attenuator can be obtained with reduced size and cost. Further, since the driving device is made of piezoelectric material, insensitive to heat and temperature change, the variable optical attenuator can be stably controlled regardless of the temperature change.

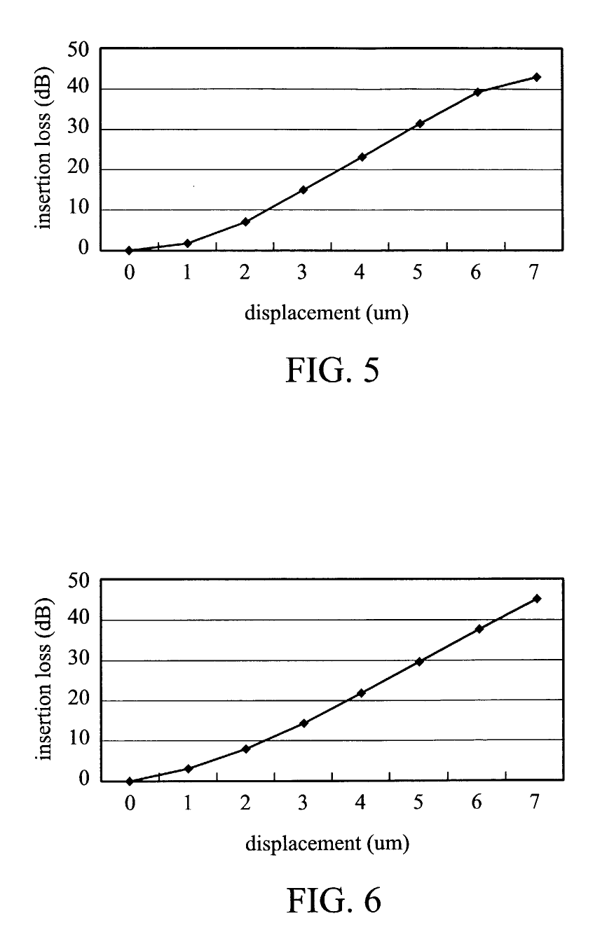

Experiments of the embodiments of the variable optical attenuator of the present invention can be described with reference to FIG. 5 and FIG. 6. FIG. 5 is a diagram showing the insertion loss (that is, the amount of attenuation of the optical signal) in relation to the displacement of the lens module (the GRIN lens 110 and the HR mirror 130) of the variable optical attenuator in the embodiment of FIG. 2, in which the GRIN lens 110 and the HR mirror 130 are moved relative to the ferrule 100 in a direction substantially perpendicular to the optical fibers 160 and 170. Further, FIG. 6 is a diagram showing the insertion loss in relation to the displacement of the lens module of the variable optical attenuator in the embodiment of FIG. 4, in which the HR mirror 130 and the GRIN lens 110 are moved and rotated relative to the ferrule 100 according to the oscillation of the piezoelectric bimorph cantilever 220. It should be noted that the displacement of the lens module with a desired insertion loss can be a combination of movement and rotation of the above-mentioned embodiments of FIGS. 5 and 6 by addition of the insertion loss of each embodiment.

It should be noted that the GRIN lens 110 of the present invention can be a conventional GRIN lens, a C-lens or any other form of lens according to the requirement of the variable optical attenuator. Further, the variable optical attenuator of the present invention can be applied in the field of MEMS; in this case, the driving device of the present invention can be a microactuator, such as a micro-motor.

While the present invention has been described with reference to the preferred embodiments thereof, it is to be understood that the invention is not limited to the described embodiments or constructions. On the contrary, the invention is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A variable optical attenuator, comprising:
a ferrule with a hole;
an optical fiber disposed in the hole of the ferrule;
a lens module having a highly reflective mirror and a GRIN lens with two surfaces, one of the two surfaces being fixed to the highly reflective mirror, and a clearance being formed between the other of the two surfaces and the ferrule; and
a driving device connected to the lens module for moving the lens module relative to the ferrule.

2. The variable optical attenuator according to claim 1, wherein the optical fiber comprises an input fiber and an output fiber.

3. The variable optical attenuator according to claim 1, wherein the driving device comprises a piezoelectric actuator.

4. The variable optical attenuator according to claim 1, wherein the driving device comprises a microactuator.

5. The variable optical attenuator according to claim 1, wherein the driving device moves the lens module relative to the ferrule in a direction substantially perpendicular to the optical fiber.

6. The variable optical attenuator according to claim 1, wherein the driving device moves the lens module relative to the ferrule in a direction substantially parallel to the optical fiber for changing the clearance between the GRIN lens of the lens module and the ferrule.

7. The variable optical attenuator according to claim 1, wherein the driving device controls the lens module to rotate relative to the ferrule for changing the clearance and an angle between the GRIN lens of the lens module and the ferrule.

8. The variable optical attenuator according to claim 1, wherein the highly reflective mirror comprises a highly reflective film coated on one of the surfaces of the GRIN lens.
